(19) United States
(12) Patent Application Publication
(10) Pub. No.: US 2023/0367012 A1
(43) Pub. Date: Nov. 16, 2023

(54) OPTICAL MEASURING DEVICE FOR SPATIALLY RESOLVED DISTANCE DETERMINATION

(71) Applicant: Fraunhofer-Gesellschaft zur Förderung der angewandten Forschung e.V., München (DE)

(72) Inventor: Wolfgang REINERT, München (DE)

(21) Appl. No.: 18/246,146

(22) PCT Filed: Sep. 20, 2021
(86) PCT No.: PCT/EP2021/075754

§ 371 Date: Mar. 21, 2023

(30) Foreign Application Priority Data
Sep. 21, 2020 (DE) 10 2020 211 784.5

(51) Int. Cl. G01S 17/48; G01S 7/481

(52) U.S. Cl. CPC G01S 17/48; G01S 7/4813; G01S 7/4812

(57) ABSTRACT

The invention relates to an optical measuring device (1) for spatially resolved distance determination, comprising: a laser light source (2), a scanning unit (4) comprising a micromirror (5) for the deflection of a scanning light (3) emitted by the laser light source (2); a photodetector (8) to detect a detection light (9) incident coaxially to on the scanning light (3); a prism unit (10) to apply scanning light (3) to the micromirror (5) and the detection light (9) to the photodetector (8), wherein the laser light source (2), the photodetector (8), and the scanning unit (4) are arranged on a common substrate (13); the scanning unit (4) comprises a dome-shaped window (14) below which the micromirror (5) is encapsulated in an airtight manner; and the prism unit (10) comprises: a first surface (15) to reflect the scanning light (3); a second surface (17) to reflect the detection light (9) to the photodetector (8) and to transmit the scanning light (3); and a third surface (18) to transmit and/or deflect the scanning light (3) and to transmit and/or deflect the detection light (9).

The invention relates to an optical measuring device for spatially resolved distance determination.

Different optical measuring devices of this kind are known from the prior art that are, for instance, suitable as a 3D camera and/or for LiDAR (light detection and ranging). The document Wang et al. (Micromachines 2020, vol. 11, issue 5, 456, doi: 10.3390/mill050456), for example, describes a LiDAR device on the basis of MEMS (micro-electromechanical systems). In this respect, a modulated laser light is incident on a MEMS mirror that scans the laser light in the direction of an object. The reflected laser light is detected by means of a photodetector and the time of flight can be evaluated to determine the distance.

Desired properties of an optical measuring device for spatially resolved distance determination include, for instance, a compact design (for instance, for installation in cellphones, notepads, laptops, AR/VR/MR glasses, and other mobile electronic systems), a long service life, and a reliable function, in particular under conditions with strong background light (sunlight for instance), high spatial resolution, a large spatial measurement range, and a high measurement speed. The known measuring devices are frequently in need of improvement as regard these properties—in particular their combination.

It is accordingly the underlying object of the present invention to provide an optical measuring device for spatially resolved distance determination that is characterized—with high resolution, a large measurement range, and a high measurement speed—by a compact design, a long service life, and a reliable function, even with strong background light.

The object is achieved in accordance with the invention by an optical measuring device in accordance with claim 1. Advantageous embodiments, further developments, and uses of the invention result together with the features of the dependent claims.

The proposed optical measuring device for spatially resolved distance determination comprises:
a laser light source, configured to emit scanning light;
a scanning unit on a MEMS basis comprising a micromirror pivotable about at least one axis for the deflection of the scanning light emitted by the laser light source into an object space and a drive for pivoting the micromirror about the at least one axis;
a photodetector, configured to detect a portion of a detection light incident coaxially to the scanning light deflected by the micromirror and reflected at the micromirror; and
a prism unit, configured to apply the scanning light emitted by the laser light source to the micromirror so that the scanning light is reflected into the object space at the micromirror and to apply the portion of the detection light reflected at the micromirror to the photodetector so that the scanning light and the detection light propagate coaxially along a first section of an optical axis extending within the prism unit and along a second section of the optical axis extending between the prism unit and the micromirror,
wherein the laser light source, the photodetector, and the scanning unit are arranged on a common planar substrate;
wherein the scanning unit comprises a dome-shaped window passed through by the second section of the optical axis and transmitting the detection light;
wherein the micromirror is encapsulated in an airtight manner between the dome-shaped window and the substrate, in particular between the dome-shaped window and a base structure of the scanning unit arranged between the micromirror and the substrate; and
wherein the prism unit comprises:
a first surface arranged above the laser light source and angled with respect to the substrate, configured to reflect a portion of the scanning light for coupling into a first optical path section extending along the first section of the optical axis;
a second surface arranged above the photodetector and angled with respect to the substrate, configured to reflect a portion of the detection light from the first optical path section to the photodetector and to transmit a portion of the scanning light reflected at the first surface; and
a third surface, configured to transmit and/or deflect the scanning light from the first optical path section into a second optical path section extending along the second section of the optical axis and to transmit and/or deflect the portion of the detection light reflected at the micromirror from the second optical path section into the first optical path section,
wherein the second section of the optical axis includes an angle of incidence with a surface of the substrate and/or with a surface or the micromirror in a neutral position that is greater than 0 degrees and smaller than 90 degrees.

A position of the micromirror is called a neutral position here from which it can be deflected by means of the drive. The neutral position can in particular be a position that the micromirror adopts in the absence of a voltage applied to the drive or on an application of a constant offset voltage to the drive. The neutral position can be selected such that an equally large deflection of the micromirror from the neutral position in a plurality of directions is possible. The neutral position can be selected such that a possible deflection of the micromirror from the neutral position in one direction is possible.

The proposed measuring device is in particular advantageously suitable for use in a method for spatially resolved distance determination that comprises the steps;
emitting the scanning light by means of the laser light source;
applying the scanning light emitted by the laser light source to the micromirror by means of the prism unit such that the scanning light emitted by the laser light source is deflected into the object space;
pivoting the micromirror by means of the drive such that the scanning light reflected at the micromirror sequentially reaches a plurality of object points in the object space;
detecting the portion of detection light incident coaxially to the scanning light deflected by the micromirror and reflected at the micromirror; and
determining the respective distance between each object point of the plurality of object points and a reference point on the basis of a relative time difference of the scanning light and the portion of deflection light detected by means of the photodetector.

Under the assumption that the portion of the detection light incident coaxially to the scanning light deflected by means of the micromirror and reflected at the micromirror is a portion of the scanning light scattered and/or reflected at objects points of the plurality of object points, said method permits a fast distance determination at high spatial resolution at static objects and in particular at dynamically moving objects over a large spatial measurement range when using the proposed measuring device.

The measuring device is characterized by the possibility of a compact and light design to which the easily miniaturizable arrangement of the laser light source, of the photodetector, and of the scanning unit on the common substrate, the prism unit in the above-described embodiment, and the second section of the optical axis entering into the scanning unit through the dome-shaped window obliquely to the surface of the substrate contribute. Particularly the construction height of the measuring device (perpendicular to the surface of the substrate) can be kept small due to these features.

At the same time, a large spatial measurement range can be achieved with comparatively small lateral dimensions (i.e. in parallel with the surface of the substrate) of the measuring device by the dome-shaped window since the scanning light is scannable over a large angular range.

A reliable function of the measuring device can furthermore also be ensured, even with strong background light, due to the easily achievable signal-to-noise ratio. An improved signal-to-noise ratio results, for instance, from the dome shape of the window by which an impingement of focused reflections of the scanning light on the photodetector is avoided or reduced. The fact that such reflections accordingly also do not have to be suppressed by means of a beam trap or similar is in turn advantageous for a compact design of the measuring device.

The easily achievable signal-to-noise ratio is also accompanied by the possibility of eye-safe operation, that is the use of a sufficiently low laser power of the scanning light to avoid eye damage.

Since the micromirror is encapsulated in an airtight manner between the dome-shaped window and the substrate, the micromirror is protected against environmental influences, which can improve the service life of the optical measuring device.

A space including the micromirror below the dome-shaped window can furthermore have an internal pressure reduced with respect to an environmental pressure. Damping that occurs on the pivoting of the micromirror is thus reduced and a corresponding mirror deflection is increased so that a particularly large measuring range, a reduced energy consumption, and a particularly good service life of the optical measuring device can be made possible.

The laser light source can be or comprise a laser light source that is time modulable, in particular operable in a pulsed manner, preferably a laser diode. The laser light source can be or comprise a continuous wave laser light source that is time modulable. The laser light source can be a VCSEL diode and/or an edge emitting laser diode. A particularly compact design can be implemented with a VCSEL diode at high energy efficiency, high beam quality, and/or high modulation frequency or pulse frequency.

A wavelength of the scanning light emitted by means of the laser light source is preferably larger than or equal to 850 nm, in particular in the range from 850 nm to 2000 nm. If the laser light source is operated in a pulsed manner, a pulse duration of the scanning light preferably amounts to 100 ps to 5 ns.

The photodetector can be or comprise an avalanche photodiode (APD) and/or a PIN diode and/or a silicon photomultiplier (SiPM) and/or a single photon avalanche diode (SPAD) and/or a detection unit having a plurality of SPAD diode cells on a chip so that a particularly compact design can be achieved with a high detection sensitivity.

The optical measuring device can comprise:
a control unit, configured to control the micromirror such that scanning light reflected at the micromirror during a pivoting of the micromirror about the at least one axis sequentially reaches a plurality of object points in the object space; and
a processing unit that is configured to determine a distance between the respective object point and a reference point on the basis of a relative time difference of the scanning light and the portion of the deflection light detected by means of the photodetector for each object point of the plurality of object points.

The processing unit can be configured in conjunction with a laser light source that is time modulable to determine the relative time difference as a time of flight or as a phase difference between the scanning light and the portion of the detection light detected by means of the photodetector. The processing unit can in particular be configured to determine the relative time difference as a time of flight between a scanning light pulse emitted by the laser light source and a detection light pulse that is detected by means of the photodetector and that is a portion of the scanning light pulse reflected and/or scattered in the object space.

The control unit can be configured only to permit the emission of a second scanning light pulse after the emission of a first scanning light pulse when a detection light pulse corresponding to the first scanning light pulse was detected or a predefined timeout interval had elapsed.

The processing unit can be configured to generate a depth image and/or an object surface reconstruction on the basis of the distances between each object point of the plurality of object points and the reference point. A depth image here is a spatially resolved representation of distances, for example with respect to a reference plane or a reference point.

The control unit can be configured to intermittently increase a laser power of the scanning light when a region in the object space is recognized from which only a small detection light signal (below a threshold value) is detected.

The control unit can be configured to regulate or control the laser power of the scanning light such that it always remains below an eye safe threshold value.

The optical measuring device can comprise a time filter that is configured to separate the portion of the detection light detected by means of the photodetector by a time gating of portions of the scanning light. It can thereby in particular be prevented that internal reflections are detected by means of the photodetector that occur within the optical measuring device.

The angle of incidence can be larger than or equal to 30 degrees and/or smaller than or equal to 50 degrees. The angle of incidence is preferably between 30 degrees and 50 degrees. It can thus in particular be achieved that an entry point at which the scanning light emitted by the laser light source passes through the dome-shaped window after passing through the prism unit is not disposed at an apex of the dome-shaped window oppositely disposed the micromirror perpendicular to the surface of the substrate or to the surface of the micromirror in the neutral position. An arranging of optical elements in the region of the apex and thus a partial blocking of the scanning light reflected into the object space at the micromirror and of the portion of the detection light coaxially incident thereto are thereby avoided.

The dome-shaped window preferably has a spherical arch. The dome-shaped window can alternatively have any other arch shape, for example an elliptical arch. An inner surface of the dome-shaped window that faces the substrate and an outer surface of the dome-shaped window that is remote from the substrate can have identical or different arch shapes.

The second section of the optical axis can pass through the dome-shaped window perpendicular to a surface of the dome-shaped window. Aberrations in the optical path can be minimized by this feature. Alternatively, the second section of the optical axis can pass through the dome-shaped window obliquely to the surface of the dome-shaped window.

The first section of the optical axis can extend in parallel with the surface of the substrate. A particularly small construction height of the optical measuring device can thus be achieved. Alternatively, the first section of the optical axis can extend obliquely to the surface of the substrate.

The prism unit can comprise a plurality of individual optical elements, with one or more of the individual components being able to be prisms.

The prism unit preferably is or comprises a composite prism comprising a first prism and a second prism. Provision can in particular be made here that the first prism comprises the first surface, the second surface is formed at a boundary surface disposed in the interior of the composite prism and between the first and second prisms, and the second prism comprises the third surface. The second surface can comprise a beam splitter coating, for example having a reflection/transmission ratio of 80:20, 70:30. 50:50, or another reflection/transmission ratio.

The first prism preferably has a parallelogram-shaped base surface. The second prism preferably has a trapezoidal base surface. The composite surface preferably has a trapezoidal base surface, with the first and second surfaces being in parallel with one another and the first and third surfaces being angled with respect to one another. The prisms can also have alternative shapes.

In accordance with another example, the prism unit can comprise a mirror comprising the first surface and/or a beam splitter comprising the second surface and/or a wedge prism comprising the third surface.

The prism unit can comprise an absorber layer to absorb scattered light and/or light reflections within the optical measuring device, whereby a measurement with improved reliability and/or an improved signal-to-noise ratio is made possible.

The prism unit can be arranged with respect to the scanning unit such that a perpendicular projection of the prism unit onto the substrate overlaps a perpendicular projection of the micromirror onto the substrate.

The optical measuring device can comprise a further photodetector likewise arranged on the substrate, configured to detect a direct portion of the detection light not reflected at the micromirror.

The further photodetector can be optically decoupled from the laser light source. Optically decoupled means that only a small portion of a power emitted as scanning light by the laser light source impinges on the further photodetector, for example less than 0.1 percent, preferably less than 0.01 percent, particularly preferably less than 0.001 percent.

The further photodetector can thus in particular be protected from internal reflections of the scanning light that occur within the optical measuring device so that the detection of the detection light is not impaired by such reflections and any detection dead time required to suppress a detection of such reflections at the first-named photodetector can be avoided. A condenser optics that is configured to apply the direct portion of the detection light to the further photodetector can furthermore have a larger aperture surface and/or a larger aperture angle than the optical path by means of which the first-named photodetector is acted on by the portion of the detection light incident coaxially to the scanning light. Due to said properties, the further photodetector can improve the distance measurement at objects that only weakly reflect the scanning light and/or that are arranged at a short distance from the measuring device. The condenser optics can comprise a Fresnel lens.

The processing unit, where present, can be configured to determine a first depth image on the basis of the coaxial portion of the detection light detected by means of the first-named photodetector and a second depth image on the basis of the direct portion of the detection light detected by means of the further photodetector. The processing unit can be configured to combine the first and second depth images into a third depth image, for example on the basis of a threshold-based segmentation and/or by means of a machine learning algorithm.

The optical measuring device can comprise a further laser light source likewise arranged on the substrate, configured to emit a scanning light having a wavelength different from a wavelength of the scanning light emitted by the first-named laser light source.

The application options of the optical measuring device can be expanded by means of such a further laser light source; for instance, measurements can be made possible on objects or parts of objects that only weakly reflect and/or scatter the wavelength of the scanning light emitted by the first-named laser light source.

If the optical measuring device comprises a further laser light source, provision can be made that the two laser light sources sequentially emit the respective scanning light and the photodetector sequentially detects the respective detection light. Alternatively, the optical measuring device can comprise an additional photodetector and provision can be made that the two laser light sources simultaneously emit the respective scanning light and the scanning light remitted by each of the two laser light sources is detected by a respective one of the photodetectors.

The micromirror can be configured to quasi-statistically pivot and/or to resonantly pivot and/or to vectorially pivot about the at least on axis. Resonant pivoting means that the micromirror is periodically driven by means of the drive at a resonant frequency of the pivoting. Quasi-static pivoting means that the micromirror is not resonantly driven. Vectorial pivoting means that the micromirror can adopt different discrete positions on the pivoting.

The micromirror can be pivotable about two axes, preferably two mutually perpendicular axes. The micromirror can be configured to simultaneously pivot about each of the two axes, in particular to simultaneously resonantly periodically pivot about each of the two axes (double resonantly) at a respective resonant frequency.

A particularly high measurement speed and an energy efficient operation of the scanning unit can be achieved with a micromirror configured to resonantly pivot, in particular to simultaneously resonantly pivot, about two axes. A sufficient scanning density in the object space can be achieved by a suitable selection of a ratio of the two resonant frequencies to set a corresponding Lissajous figure.

The optical measuring device can comprise a compensation optics arranged above the laser light source, configured to compensate a divergence of the scanning light caused by the dome-shaped window.

The optical measuring device can comprise a barrier filter that is arranged above the photodetector and that is configured to transmit a narrow wavelength band that comprises a wavelength of the detection light and to block wavelengths outside the wavelength band (by reflection and/or absorption). The narrow wavelength band can have a width of, for example, 10 nm, 20 nm, or 30 nm. The prism unit and/or the dome-shaped window and/or one or more other optical components of the optical measuring device can comprise an anti-reflection coating to suppress reflections of a background light. On a use of a barrier filter and/or an anti-reflection coating, a particularly good suppression of background light, for example sunlight, and thus a particularly good signal-to-noise ratio can be achieved.

Embodiments of the invention will be explained in the following with reference to FIG. 1 to. There are shown, schematically in each case,

FIG. 1 a longitudinal section of an optical measuring device in accordance with a first example;

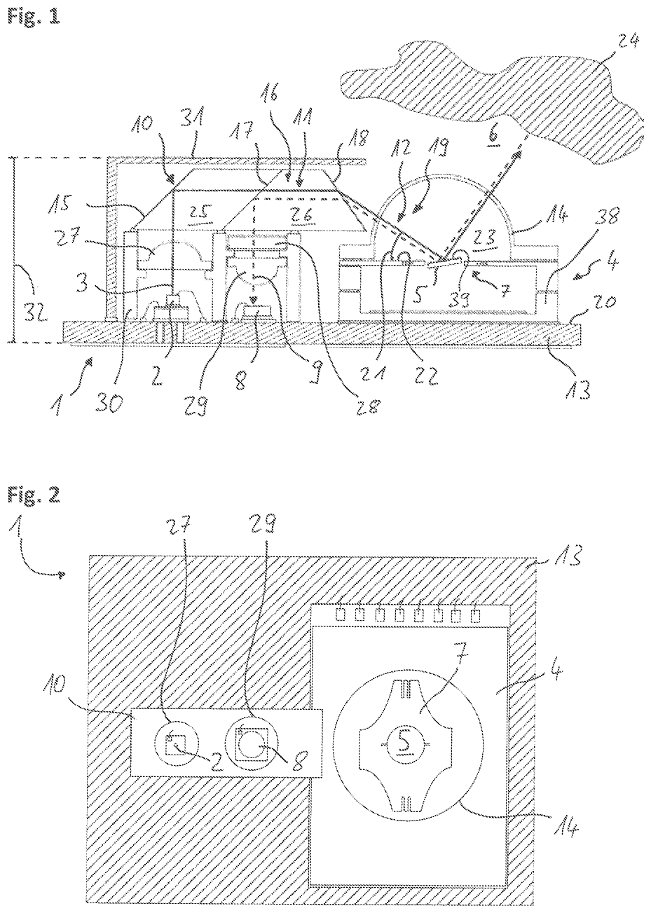

FIG. 2 a front view of the optical measuring device in accordance with FIG. 1;

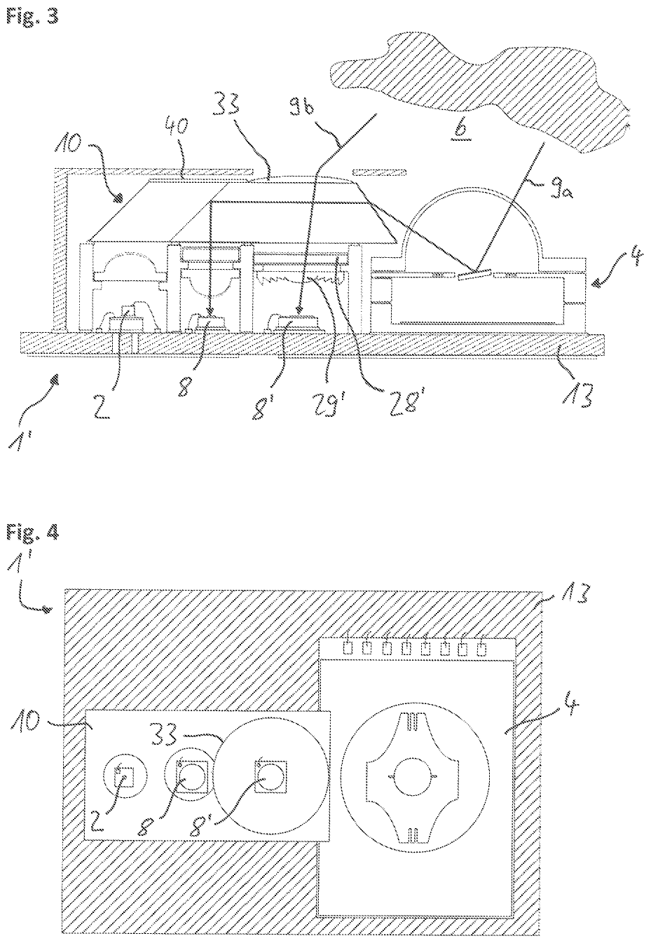

FIG. 3 a longitudinal section of an optical measuring device in accordance with a second example;

FIG. 4 a plan view of the optical measuring device in accordance with FIG. 3;

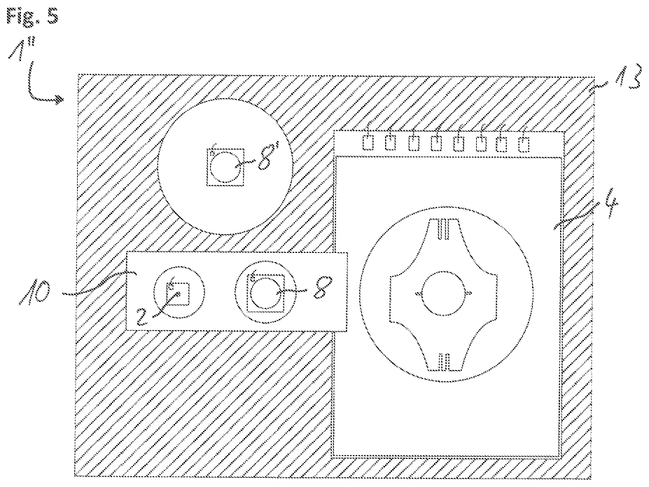

FIG. 5 a plan view of an optical measuring device in accordance with a third example;

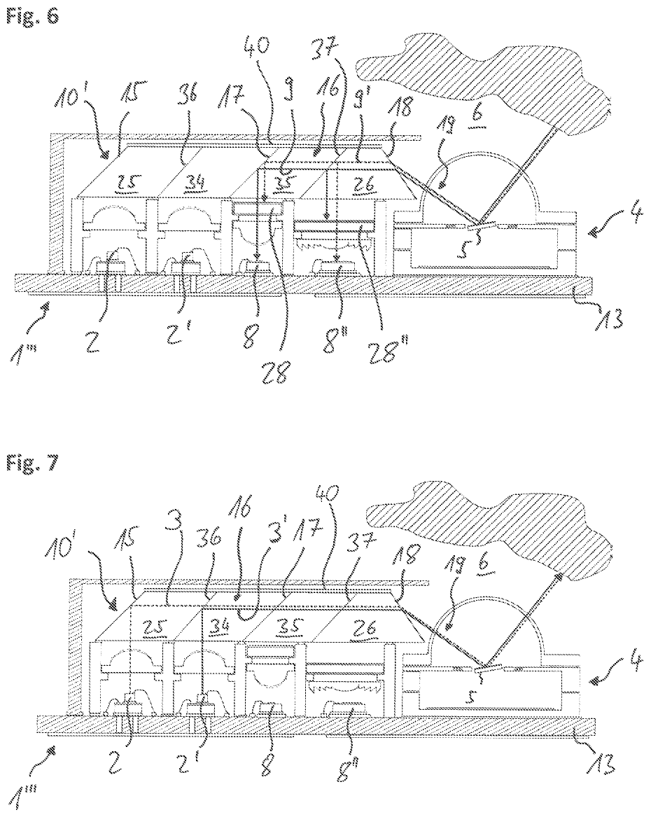

FIG. 6 and FIG. 7 longitudinal sections of an optical measuring device in accordance with a fourth example.

Repeating and similar features of different embodiments are provided with identical or similar alphanumeric reference numerals in the Figures.

The optical measuring device 1 shown in FIG. 1 and FIG. 2 for spatially resolved distance determination comprises:
a laser light source 2, configured to emit scanning light 3;
a scanning unit 4 on a MEMS basis comprising a micromirror 5 pivotable about two mutually perpendicular axes for the deflection of the scanning light 3 emitted by the laser light source into an object space 6 and a support 7 that is connected to a drive for pivoting the micromirror 5 about the two axes;
a photodetector 8, configured to detect a portion of a detection light 9 incident coaxially to the scanning light 3 deflected by means of the micromirror 5 and reflected at the micromirror; and
a prism unit 10, configured to apply scanning light 3 emitted by the laser light source 2 to the micromirror 5 so that the scanning light 3 is reflected into the object space 6 at the micromirror 5 and to apply the portion of the detection light 9 reflected at the micromirror 5 to the photodetector 8 so that the scanning light 3 and the detection light 9 propagate coaxially along a first section 11 of an optical axis extending within the prism unit 10 and along a second section 12 of the optical axis extending between the prism unit 10 and the micromirror 5. Coaxially propagating light portions are shown displaced with respect to one another in part for reasons of clarity in the drawings.

The laser light source 2, the photodetector 8, and the scanning unit 4 are arranged on a common planar substrate 13.

The scanning unit 4 comprises a dome-shaped window 14 passed through by the second section 12 of the optical axis and transmitting the scanning light 3 and the detection light 9.

The micromirror 5 is encapsulated in an airtight manner between the dome-shaped window 14 and a base structure 38 of the scanning unit 4 arranged between the micromirror 5 and the substrate 13.

The prism unit 10 comprises:
a first surface 15 arranged above the laser light source 2 and angled with respect to the substrate 13, configured to reflect a portion of the scanning light 3 for coupling into a first optical path section 16 extending along the first section 11 of the optical axis;
a second surface 17 arranged above the photodetector 8 and angled with respect to the substrate 13, configured to reflect a portion of the detection light 9 from the first optical path section 16 to the photodetector 8 and to transmit a portion of the scanning light 3 reflected at the first surface 15; and
a third surface 18, configured to transmit and deflect the scanning light 3 from the first optical path section 16 into a second optical path section 19 extending along the second section 12 of the optical axis and to transmit and deflect the portion of the detection light 9 reflected at the micromirror 5 from the second optical path section 19 into the first optical path section 16.

The second section 11 of the optical axis includes an angle of incidence 21 (shown here with respect to a surface 22 of the support 7 in parallel with the surface 20 of the substrate 13) with a surface 20 of the substrate 13 that is greater than 0 degrees and smaller than 90 degrees. In other words, the second section 11 of the optical axis passes through the dome-shaped window 14 obliquely to the surface 20 of the substrate 13.

In the example shown, a surface 39 of the micromirror 5 is arranged in a neutral position in parallel with the surface 20 of the substrate 13. The second section 11 of the optical axis therefore includes the identical angle of incidence 21 with the surface 39 of the micromirror 5. In the neutral position of the present example, not shown here, the surface 39 of the micromirror 5 is in parallel with the surface 22 of the support 7.

Provision can alternatively be made that the surface 39 of the micromirror 5 in the neutral position is tilted with respect to the surface 20 of the substrate 13; for example in that the scanning unit 4 is arranged on a wedge arranged between the substrate 13 and the base structure 38 of the scanning unit 4. In this case, the second section 11 of the optical axis includes an angle of incidence with the micromirror 5 that is greater than 0 degrees and smaller than 90 degrees. An angle between the surface 20 of the substrate 13 and the second section 11 of the optical axis can in this case have a value outside said range, for instance a value of 0 degrees.

A space 23 below the dome-shaped window 14 containing the micromirror 5 has an internal pressure reduced with respect to an environmental pressure.

The laser light source 2 is a VCSEL diode that is operable in a pulsed manner, with a pulse duration of the scanning light being able to be, for example, in the range from 100 ps to 5 ns. A wavelength of the scanning light emitted by means of the laser light source is 850 nm, for example, but can also be a different wavelength, for example 905 nm, 940 nm, 1350 nm, or a different wavelength that is larger than 850 nm.

The laser light source 2 can alternatively be a different kind of laser light source. The laser light source 2, for example, can be or comprise a laser light source that is time modulable, in particular operable in a pulsed manner, preferably a laser diode. The laser light source 2 can be or comprise a continuous wave laser light source that is time modulable. The laser light source can be or comprise an edge emitting laser diode.

The photodetector 8 is an avalanche photodiode (APD). The photodetector 8 can alternatively be a different kind of photodetector. The photodetector 8 can, for example, be or comprise a PIN diode and/or a single photon avalanche diode (SPAD).

The optical measuring device 1 comprises an amplifier circuit, for example a transimpedance amplifier circuit, configured to output a voltage that is proportional to a detector current corresponding to the portion of the detection light 9 detected by means of the photodetector 8. In addition, the optical measuring device 1 comprises a time filter that is configured to separate the portion of the detection light 9 detected by means of the photodetector 8 by a time gating of portions of the scanning light. The time gating can, for instance, take place by a time cycled switching on and off of the amplifier circuit to generate a dead detection time.

The optical measuring device 1 further comprises
a time-to-digital converter for determining a relative time difference of the scanning light 3 and of the portion of the detection light 9 detected by means of the photodetector 8;
a control unit, configured to control the micromirror 5 such that the scanning light 3 reflected at the micromirror 5 during a pivoting of the micromirror 5 about the at least one axis sequentially reaches a plurality of object points in the object space 6; and
a processing unit that is configured to determine a distance between the respective object point and a reference point on the basis of the relative time difference of the scanning light 3 and the portion of the deflection light 9 detected by means of the photodetector 8 for each object point of the plurality of object points.

The object points of the plurality of object points are here points of an object 24 in the object space 6, for example. The portion of the detection light 9 incident coaxially to the scanning light 3 deflected by means of the micromirror 5 and reflected at the micromirror 5 is a portion of the scanning light 9 scattered and/or reflected at object points of the plurality of object points.

The processing unit is configured to determine the relative time difference as a time of flight between a scanning light pulse emitted by the laser light source 2 and a detection light pulse that is detected by means of the photodetector 8 and that is a portion of the scanning light pulse reflected and/or scattered in the object space 6. The processing unit is further configured to generate a depth image and/or an object surface reconstruction on the basis of the distances between each object point of the plurality of object points and the reference point.

The control unit and the processing unit can be designed as separate units or can be integrated together in a circuit or processor unit. The control unit and/or the processing unit can be integrated on the substrate 13. The optical measuring device 1 can also be designed without the control unit and/or the processing unit. In this case, the optical measuring device 1 can be connectable to a control unit and/or to a processing unit of the described kind.

The angle of incidence 22 amounts to approximately 30 degrees in the example shown. Different values of the angle of incidence 22 are possible; the angle of incidence 22 can, for example, be greater than or equal to 30 degrees and/or smaller than or equal to 50 degrees.

The dome-shaped window 14 has a spherical arch, with the micromirror 5 being arranged at the center of the spherical arch so that the second section 12 of the optical axis passes through the dome-shaped window 14 perpendicular to its surface. The dome-shaped window 14 can alternatively have different arch shapes and/or the second section 12 of the optical axis can pass through the dome-shaped window 14 obliquely to its surface.

The first section 11 of the optical axis extends in parallel with the surface 20 of the substrate 13. Alternatively, the first section 11 of the optical axis can extend obliquely to the surface 20 of the substrate 13.

The prism unit 10 is a composite prism comprising a first prism 25 and a second prism 26. The first prism 25 here comprises the first surface 15, the second surface 17 is formed at a boundary surface disposed in the interior of the composite prism and between the first prism 25 and the second prism 26, and the second prism 26 comprises the third surface 18. The second surface comprises a beam splitter coating, for example having a reflection/transmission ratio of 70:30 (i.e. in particular 70 percent of the portion of the detection light incident coaxially to the scanning light 3 deflected by means of the micromirror 5 and reflected at the micromirror 5 is reflected in the direction of the photodetector 8 at the second surface 17; 30 percent is transmitted in the direction of the first prism), with alternatively different reflection/transmission ratios also being able to be provided.

The first prism 25 has a parallelogram shaped base surface, the second prism 26 a trapezoidal base surface so that the composite prism has a trapezoidal base surface, with the first surface 25 and the second surface 26 being in parallel with one another and the first surface 25 and the third surface 26 being angled with respect to one another. The prism unit 10 can be designed in a different manner; for example, the prism unit 10 can comprise a mirror comprising the first surface 15 and/or a beam splitter comprising the second surface 17 and/or a wedge prism comprising the third surface 18.

As can easily be recognized in FIG. 2, the prism unit 10 is arranged with respect to the scanning unit 4 such that a perpendicular projection of the prism unit 10 onto the substrate 13 does not overlap a perpendicular projection of the micromirror 5 onto the substrate 13. An overlap of said projections can also be provided depending on the value of the angle of incidence 21.

The micromirror 5 is configured to pivot simultaneously resonantly periodically about each of the two pivot axes at a respective resonant frequency (double resonance).

The micromirror 5 can also be configured to quasistatically pivot and/or to vectorially pivot about one or more axes. The optical measuring device 1 can comprise a further micromirror pivotable about one or more pivot axes in some embodiments.

The drawings show by way of example a support 7 that pivotably supports the micromirror 5 about two pivot axes that are perpendicular to one another and is connected, for example, to an electrostatic drive. Alternatively, a different support geometry can be provided, for instance with pivot axes not perpendicular to one another and/or a different drive can be provided, for instance an electromagnetic or piezoelectric drive.

The optical measuring device 1 has a lens arranged above the laser light source 2 as a collimation and compensation optics 27 that is configured to substantially collimate the scanning light 3 emitted by the laser light source 2, but simultaneously to compensate a divergence of the scanning light 3 caused by the dome-shaped window 14. In some embodiments, for instance with a sufficiently collimated laser light source 2, the collimation and compensation optics 27 can also be omitted.

The optical measuring device 1 has a barrier filter 28 that is arranged above the photodetector and that is configured to transmit a narrow wavelength band (for example 20 nm) that comprises a wavelength of the detection light and to block wavelengths outside the wavelength band. The optical measuring device further has a condenser lens 29 that is arranged above the photodetector 8 and that is configured to focus the portion of the detection light 9 incident coaxially to the scanning light 3 deflected by means of the micromirror 5 and reflected at the micromirror 5.

The collimation and compensation optics 27, the barrier filter 28, and the condenser lens 29 are attached in a component holder 30 arranged on the substrate 13. The component holder 30 also supports the prism unit 10. The optical measuring device 1 further comprises a cover 31 to protect the optical components and to suppress scattered light (the cover 31 is not shown in FIG. 2).

A scannable angular range of 175 degrees can, for example, be achieved with an optical measuring device of the kind shown with a distance measuring range of up to 10 m with sunlight irradiation, with a distance measurement precision of, for instance, up to 3 mm being able to be reached. An object point measuring frequency of up to 20 MHz and/or a frame rate of up to 240 fps can be implemented with the double resonant micromirror, for example. An overall construction height 32 of, for example, less than 6 mm can be achieved with a total volume of the optical measuring device 1 of approximately 0.4 cm³ due to the compact design.

In the following, only those respective features of further embodiments are described that substantially differ from the above-described example.

The optical measuring device 1′ shown in FIG. 3 and FIG. 4 has a further photodetector S′ that is likewise arranged on the substrate 13 in addition to the photodetector 8 that is configured to detect the coaxial portion 9a of the detection light. The photodetector S′ is configured to detect a direct portion 9b of the detection light not reflected at the micromirror 5.

The optical measuring device 1′ has a barrier filter 2S′ that is arranged above the photodetector 8′ and that is configured to transmit a narrow wavelength band (for example 20 nm) that comprises a wavelength of the detection light and to block wavelengths outside the wavelength band. The optical measuring device 1 further has a condenser lens 29′—designed as a Fresnel lens here —arranged above the photodetector 8′, with the direct portion 9b of the detection light reaching the photodetector 8′, that has a detector surface increased with respect to the photodetector 8 in the example shown, in a defocused manner.

With respect to the photodetector S, the photodetector S′ is characterized by a particularly large entry surface 33 in the optical path through which the direct portion 9b is supplied to the photodetector 8′. In the example shown, the direct portion 9b of the detection light impinges on the photodetector 8′ through the prism unit 10. The prism unit 10 has an absorber layer 40 arranged at as side of the prism (beside the entry surface 33) remote from the substrate 13.

The processing unit in this example can be configured to determine a first depth image on the basis of the coaxial portion 9a of the detection light detected by means of the photodetector 8 and a second depth image on the basis of the direct portion 9b of the detection light detected by means of the photodetector 8′ on the basis of a threshold-based segmentation and/or by means of a machine learning algorithm.

With the optical measuring devices 1″ shown in FIG. 5, the further photodetector 8′ is optically decoupled from the laser light source 2 in that it is arranged on the substrate 13 beside the prism unit 10. Only an extremely small portion of a power emitted by the laser light source 2 as scanning light thereby impinges on the photodetector 8′, for instance less than 0.01 percent. Due to the optical decoupling, the photodetector 8′ is in particular protected from internal reflections of the scanning light that occur within the optical measuring device.

The optical measuring device 1″ shown in FIG. 6 and FIG. 7 comprises a further laser light source 2′ likewise arranged on the substrate 13, configured to emit a scanning light 3′ having a wavelength (second wavelength) different from a wavelength of the scanning light 3 emitted by the first-named laser light source 2 (first wavelength). The micromirror 5 is furthermore also configured to deflect the scanning light 3′ emitted by the further laser light source 2′ into the object space 6.

The optical measuring device 1′″ has an additional photodetector 8″ likewise arranged on the substrate 13 in addition to the photodetector 8. Whereas the first-named photodetector 8 is configured to detect a portion of the detection light 9 of the first wavelength incident coaxially to the scanning light 3/3′ deflected by means of the micromirror 5 and reflected at the micromirror 5, the additional photodetector 8″ is configured to detect a portion of the detection light 9′ of the second wavelength likewise incident coaxially to the scanning light 3/3′ deflected by means of the micromirror 5 and reflected at the micromirror 5.

Measurements at objects or parts of objects can thus be made possible, for instance, that only weakly reflect and/or scatter the first wavelength, but the second wavelength more strongly. Exemplary combinations of the first/second wavelengths are, for instance, 850 nm/905 nm, 905 nm/940 nm, 940 nm/1350 nm, or other combinations of said wavelengths or other wavelengths, in particular in the range from 850 nm to 2000 nm.

Instead of the prism unit 10, the optical measuring device 1′″ comprises the prism unit 10′ that is designed as a four-part composite prism that comprises a third prism 34 and a fourth prism 35 in addition to the first prism 25 and the second prism 26.

In this respect—as with the prism unit 10—the first prism 25 comprises the first surface 15 arranged above the laser light source 2, angled with respect to the substrate 13, and configured to reflect a portion of the scanning light 3 for coupling into the first optical path section 16; the second prism 26 comprises the third surface 18 configured to transmit and deflect the scanning light 3/3′ from the first optical path section 16′ into the second optical path section 19 and to transmit and deflect the portion of the detection light 9/9′ reflected at the micromirror 5 from the second optical path section 19 into the first optical path section 16.

The second surface 17 arranged above the photodetector 8, angled with respect to the substrate 13, and configured to reflect a portion of the detection light 9/9′ from the first optical path section 16 to the photodetector 8 and to transmit a portion of the scanning light 3/3′ is formed at a boundary surface disposed in the interior of the composite prism between the third prism 34 and the fourth prism 35.

The prism unit 10′ further comprises a fourth surface 36 formed at a boundary surface between the first prism 25 and the third prism 34 and a fifth surface 37 formed at a boundary surface between the fourth prism 36 and the second prism 26. The fourth surface 36 is configured to reflect a portion of the scanning light 3′ for coupling into the first optical path section 16. The fifth surface 37 is configured to reflect a portion of the detection light 9/9′ from the first optical path section 16 to the photodetector 8″ and to transmit a portion of the scanning light 3/3′.

Like the prism unit 10, the prism unit 10′ also has an absorber layer 40 arranged at a side of the prism remote from the substrate 13.

Alternatively, the prism unit 10 can in turn be designed in a different manner or from different individual components.

The optical measuring device 1′″ further comprises a barrier filter 28 arranged above the photodetector 8, configured to transmit a narrow wavelength band that comprises the first wavelength and a barrier filter 28″ arranged above the photodetector 8″, configured to transmit a narrow wavelength band that comprises the second wavelength, with the barrier filters 28 and 28″ being configured to block wavelengths outside the respective wavelength band. The photodetector 8 thus substantially only detects the detection light 9 of the first wavelength, the photodetector 8″ substantially only the detection light 9′ of the second wavelength.

The processing unit in this example can be configured to determine a first depth image on the basis of the portion of the detection light 9 of the first wavelength detected by means of the photodetector 8 and a second depth image on the basis of the portion of the detection light 9″ of the second wavelength detected by means of the photodetector 8″ on the basis of a threshold-based segmentation and/or by means of a machine learning algorithm.

The optical measuring device 1′″ can comprise a further photodetector in particular optically decoupled form the laser light source 2, 2′ in addition to the photodetectors 8, 8′, configured to detect a direct portion of the detection light not reflected at the micromirror 5.

### LIST OF REFERENCE NUMERALS

1, 1′, 1″, 1′″ optical measuring device
2, 2′ laser light source
3, 3′ scanning light
4 scanning unit
5 micromirror
6 object space
7 support
8, 8′, 8″ photodetector
9, 9′ detection light
9a coaxial portion of the detection light
9b direct portion of the detection light
10, 10′ prism unit
11 first section of the optical axis
12 second section of the optical axis
13 substrate
14 dome-shaped window
15 first surface
16 first optical path section
17 second surface
18 third surface
19 second optical path section
20 surface of the substrate
21 angle of incidence
22 surface of the support
23 space below the dome-shaped window
24 object
25 first prism
26 second prism
27 collimation and compensation optics
28, 28′, 28″ barrier filter
29, 29′ condenser lens
30 component holder
31 cover
32 overall construction height
33 entry surface
34 third prism
35 fourth prism
36 fourth surface
37 fifth surface
38 base structure
39 surface of the micromirror
40 absorber layer

1. An optical measuring device for spatially resolved distance measurement, comprising:
a laser light source configured to emit a scanning light; and
a scanning unit on a micro-electromechanical system (MEMS) base comprising:
a micromirror pivotable about at least one axis configured for the deflection of the scanning light emitted by the laser light source into an object space;
a drive for pivoting the micromirror about the at least one axis;
a photodetector configured to detect a portion of detection light, wherein the deflection light is incident coaxially to the scanning light, deflected by the micromirror, and reflected at the micromirror; and
a prism unit, configured to apply scanning light emitted by the laser light source to the micromirror so that the scanning light is reflected into the object space at the micromirror and to apply the portion of the detection light reflected at the micromirror to the photodetector so that the scanning light and the detection light and the detection light propagate coaxially along a first section of an optical axis extending within the prism unit and along a second section of the optical axis extending between the prism unit and the micromirror;
wherein the laser light source, the photodetector, and the scanning unit are arranged on a common planar substrate, wherein the scanning unit comprises a dome-shaped window passed through by the second section of the optical axis and transmitting the scanning light and the detection light, wherein the micromirror is encapsulated in an airtight manner between the dome-shaped window and the common planar substrate, and wherein the prism unit comprises:
a first surface arranged above the laser light source and angled with respect to the common planar substrate, configured to reflect a portion of the scanning light for coupling into a first optical path section extending along the first section of the optical axis;
a second surface arranged above the photodetector and angled with respect to the common planar substrate, configured to reflect a portion of the detection light from the first optical path section to the photodetector and to transmit a portion of the scanning light reflected at the first surface; and
a third surface, configured to at least one of transmit or deflect the scanning light from the first optical path section into a second optical path section extending along the second section of the optical axis and to transmit and/or deflect the portion of the detection light reflected at the micromirror from the second optical path section into the first optical path section, wherein the second section of the optical axis includes an angle of incidence with at least one of a surface of the common planar substrate or with a surface of the micromirror in a neutral position that is greater than 0 degrees and smaller than 90 degrees.

2. The optical measuring device in accordance with claim 1, wherein the angle of incidence is greater than or equal to 30 degrees and smaller than or equal to 50 degrees, wherein the first section of the optical axis extends in parallel with the surface of the substrate and wherein the second section of the optical axis passes through the dome-shaped window perpendicular to a surface of the dome-shaped window.

3. The optical measuring device in accordance with claim 1, further comprising:
a control unit, configured to control the micromirror such that the scanning light reflected at the micromirror during a pivoting of the micromirror about the at least one axis sequentially reaches a plurality of object points in the object space; and
a processing unit that is configured to determine a distance between a respective object point and a reference point based on a relative time difference of the scanning light and the portion of the deflection light detected using the photodetector for each object point of the plurality of object points.

4. The optical measuring device in accordance with claim 1, comprising:
a time filter configured to separate the portion of the detection light detected by the photodetector by a time gating of one or more portions of the scanning light.

5. The optical measuring device, in accordance with claim 1, further comprising:
a second photodetector arranged on the common planar substrate and optically decoupled from the laser light source, the second photodetector configured to detect a direct portion of the detection light not reflected at the micromirror.

6. The optical measuring device in accordance with claim 1, further comprising:
a second laser light source arranged on the common planar substrate, the second laser light source configured to emit a scanning light having a wavelength different from a wavelength of the scanning light emitted by the laser light source.

7. The optical measuring device in accordance with claim 1, wherein the micromirror is pivotable about two axes and is configured to simultaneously resonantly periodically pivot about each of the two axes at a respective resonant frequency.

8. The optical measuring device in accordance with claim 1, wherein the laser light source comprises a vertical cavity surface emitting laser (VCSEL) diode.

9. The optical measuring device, in accordance with claim 1, further comprising:
a compensation optical component arranged above the laser light source, configured to compensate a divergence of the scanning light caused by the dome-shaped window.

10. The optical measuring device, in accordance with claim 1, further comprising:
a barrier filter arranged above the photodetector, configured to:
transmit a narrow wavelength band that comprises a wavelength of the detection light; and
block wavelengths outside the wavelength band.

11. The optical measuring device according to claim 7, wherein the two axes are perpendicular to one another.

12. The optical measuring device according to claim 8, wherein the photodetector comprises an avalanche photodiode.

13. A method for spatially resolved distance determination, the method comprising:
emitting a scanning light from a laser light source;
directing the scanning light emitted by the laser light source to a micromirror using a prism unit so that the scanning light is deflected into an object space;
pivoting the micromirror so that the scanning light is reflected at the micromirror and sequentially reaches multiple object points in the object space;
detecting at least a portion of detection light incident coaxially to the scanning light deflected by and reflected at the micromirror by a photodetector; and
determining a respective distance between each object point of the multiple object points and a reference point based on a relative time difference of the scanning light and the at least a portion of the detection light detected by the photodetector.

14. The method of claim 13, wherein the micromirror and the prism unit are located on a scanning unit.

15. The method of claim 14, wherein the laser light source, the photodetector, and the scanning unit are arranged on a common planar substrate.

16. The method of claim 14, wherein the scanning unit comprises a dome-shaped window.

17. The method of claim 16, wherein the scanning light and the detection light propagate coaxially along a first section of an optical axis extending within the prism unit and along a second section of the optical axis, wherein the second section of the optical axis extends between the prism unit and the micromirror, and wherein the second section of the optical axis passes through the dome-shaped window.

18. The method of claim 13, comprising:
separating the at least a portion of the detection light detected by the photodetector by a time gating of one or more portions of the scanning light; and
detecting a direct portion of the detection light not reflected at the micromirror using a second photodetector.

19. An optical measuring device for spatially resolved distance measurement, comprising:
means for emitting a scanning light;
means for directing the emitted scanning light to a micromirror so that the scanning light is deflected into an object space;
means for pivoting the micromirror so that the scanning light is reflected at the micromirror and sequentially reaches multiple object points in the object space;
means for detecting at least a portion of detection light incident coaxially to the scanning light deflected by and reflected at the micromirror; and
means for determining a respective distance between each object point of the multiple object points and a reference point based on a relative time difference of the scanning light and the at least a portion of the detected detection light.

20. The optical measuring device of claim 19, comprising:
means separating the at least a portion of the detection light by a time gating of one or more portions of the scanning light; and
means for detecting a direct portion of the detection light not reflected at the micromirror.
